(19) United States
(12) Patent Application Publication
(10) Pub. No.: US 2012/0207212 A1
(43) Pub. Date: Aug. 16, 2012

(54) VISUALLY MASKED METRIC FOR PIXEL BLOCK SIMILARITY

(75) Inventors: Yao-Chung Lin, Mountain View, CA (US); Feng Yi, San Jose, CA (US); Xiaosong Zhou, Campbell, CA (US); Hsi-Jung Wu, San Jose, CA (US)

(73) Assignee: APPLE INC., Cupertino, CA (US)

(21) Appl. No.: 13/075,282

(22) Filed: Mar. 30, 2011

Related U.S. Application Data
(60) Provisional application No. 61/441,952, filed on Feb. 11, 2011.

(51) Int. Cl. H04N 7/26

(52) U.S. Cl. 375/240.08; 375/E07.076

(57) ABSTRACT

Selecting a coding mode for coding video data by measuring a distortion sensitivity threshold for a pixel block, calculating a distortion threshold representative of the maximum distortion that may be effectively masked by the brightness and texture of the pixel block, estimating the distortion induced by coding the pixel block according to skip mode and coding the source pixel block with a predictive coding technique if the estimated distortion value exceeds the distortion threshold. The distortion sensitivity threshold may include, for example, a brightness value or a texture value. The contrast between the pixel block and the surrounding pixel blocks may also be considered such that if the contrast exceeds a contrast threshold calculated based on the measurement of brightness and texture, the source pixel block may be coded with a predictive coding technique even if the estimated distortion value does not exceed the distortion threshold.

### RELATED APPLICATION

This application claims benefit under 35 U.S.C. §119(e) of U.S. Provisional Application No. 61/441,952, filed Feb. 11, 2011, which is incorporated herein by reference in its entirety.

### BACKGROUND

Aspects of the present invention relate generally to the field of video processing, and more specifically to selecting an appropriate mode for coding video data.

In conventional video coding systems, an encoder may code a source video sequence into a coded representation that has a smaller bit rate than does the source video and thereby achieve data compression. Video coding systems initially may separate a source video sequence into a series of frames, each frame representing a still image of the video. A frame may be further divided into blocks of pixels. Each frame of the video sequence may then be coded on a block-by-block basis according to any of a variety of different coding techniques. For example, using predictive coding techniques, some frames in a video stream may be coded independently (intra-coded I-frames) and some other frames may be coded using other frames as reference frames (inter-coded frames, e.g., P-frames or B-frames). P-frames may be coded with reference to a single previously coded frame and B-frames may be coded with reference to a pair of previously coded frames. A decoder may then invert the coding processes performed by the encoder to retrieve the source video. Reference frames may be temporarily stored by both the encoder and the decoder for future use in inter-frame coding and decoding.

Some frames, blocks, or macroblocks may not be coded with a predictive technique, for example some pixel blocks may be coded with a ‘skip mode.’ Skip mode coding avoids resource expensive predictive coding and decoding techniques for coding a pixel block by marking a block as skipped during encoding and copying a pixel block from a reference frame into a reconstructed picture during decoding. A skip mode coded pixel block may be directly copied from a co-located region of the reference frame into the reconstructed picture, or may be coded from a displaced region using an implied motion vector as determined by evaluating motion vectors of neighboring pixel blocks in the frame.

A video encoder may select from a variety of coding modes to code video data, and each different coding mode may yield a different level of compression, depending upon the content of the source video. In some video coding systems, a video encoder may code each portion of an input video sequence (for example, each pixel block) according to multiple coding techniques and examine the results to select a preferred coding mode for the respective portion. For example, the video encoder might code the pixel block according to a variety of coding techniques, decode the coded pixel block and estimate whether distortion induced in the decoded pixel block by the coding process would be perceptible. In some conventional encoders, coding mode decisions are based on a bit rate or distortion cost. Then either the distortion or bit-rate cost, or a combination of the two for a given coding mode may be used to select a coding mode for the respective pixel block. Coding mode decisions may identify the best pixel block coding modes supported by the video coding system.

The skip mode uses significantly less bandwidth and processing resources than predictive coding modes. Although bit-rate efficient, an improper skip decision can cause noticeable artifacts when the skip mode coded frame is decoded and displayed. A rate-distortion cost for skip mode is conventionally dominated by the distortion cost because the bit rate is minimal. This imbalanced cost metric often leads to improper skip mode decisions.

Accordingly, there is a need in the art for a video encoding system capable of effectively taking advantage of the low bandwidth skip mode without introducing visible artifacts to the image.

### BRIEF DESCRIPTION OF THE DRAWINGS

The foregoing and other aspects of various embodiments of the present invention will be apparent through examination of the following detailed description thereof in conjunction with the accompanying drawing figures in which similar reference numbers are used to indicate functionally similar elements.

FIG. 1 is a simplified block diagram illustrating components of an exemplary video coding system according to an embodiment of the present invention.

FIG. 2 is a simplified block diagram illustrating components of an exemplary encoder according to an embodiment of the present invention.

FIG. 3 is a simplified flow diagram illustrating a method for selecting a coding mode according to an embodiment of the present invention.

FIG. 4 is a simplified block diagram illustrating components of an exemplary encoder according to an embodiment of the present invention.

FIG. 5 is a simplified flow diagram illustrating a method for selecting a coding mode according to an embodiment of the present invention.

FIG. 6 is a simplified flow diagram illustrating a method for selecting a coding mode according to an embodiment of the present invention.

### DETAILED DESCRIPTION

In homogenous or dark regions of a picture, discrepancies are often more obvious than in highly textured or bright regions of a picture where noise and distortion induced artifacts blend in more naturally with the image content and can more easily be masked. Thus an efficient selection of coding mode may be based on the content of the pixel block in question including a measurement of image texture and brightness. Skip mode decisions with a higher risk of inducing distortion, in particular, may benefit from a consideration of the image content of the pixels being coded. Then improper skip mode decisions that result in noticeable distortion will be avoided. Testing the distortion induced with the skip mode against the threshold distortion that may be adequately masked by the image content of the pixel blocks before attempting resource intensive predictive coding modes may result in a more efficient mode selection without relying on bit-rate/distortion balancing methods that improperly weight the skip mode.

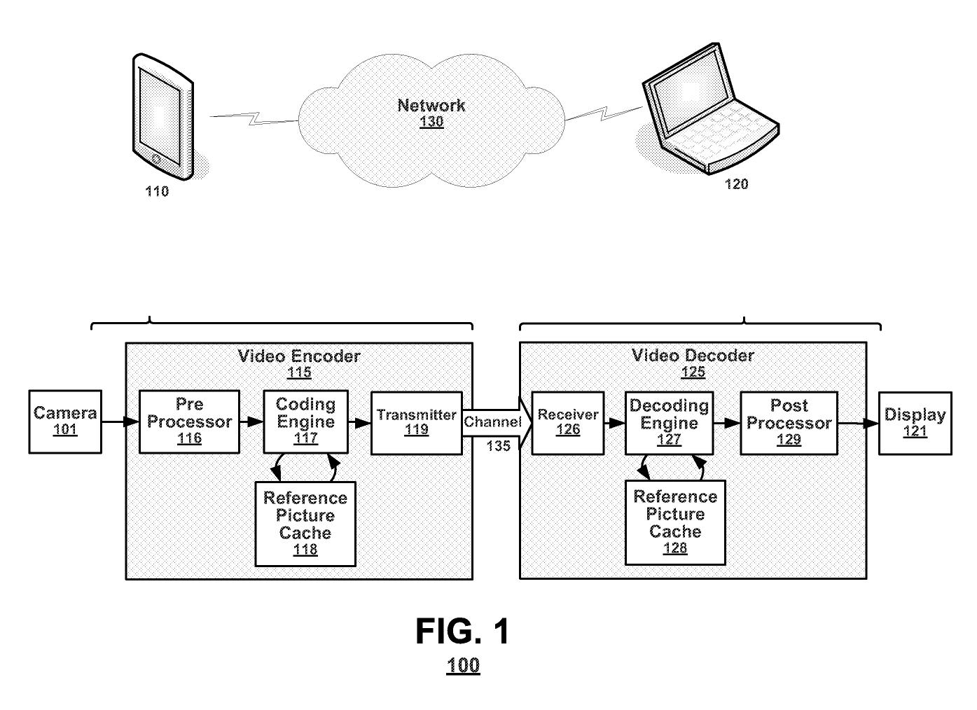

FIG. 1 is a simplified block diagram illustrating components of an exemplary video coding system 100 according to an embodiment of the present invention. A video coding system 100 may include terminals 110, 120 that communicate via a network 130. The terminals 110, 120 may capture video data locally and code the video data for transmission to another terminal via the network 130. Each terminal 110, 120 may receive the coded video data from other terminals on the network 130, decode the coded data and display the recovered video data. Terminals may include personal computers (both desktop and laptop computers), tablet computers, handheld computing devices, computer servers, media players and/or dedicated video conferencing equipment.

As shown, the video coding system 100 may include a terminal 110 with an encoder 115 that encodes video data for transmission on the network 130. Using a selected coding mode, the encoder 115 may then compress the processed video data. The resulting compressed sequence may occupy less bandwidth than the original video data when it is transmitted to a decoder 125 at a second terminal 120 via a channel 135 on the network 130. The channel 135 may be a transmission medium provided by communications or computer networks. Representative networks include telecommunications networks, local area networks, wide area networks and/or the Internet. The channel 135 may transmit data in circuit-switched or packet-switched channels.

The encoder 115 may include a pre-processor 116, a coding engine 117, a reference picture cache 118 and a transmitter 119. The encoder 115 may receive an input source video sequence from a video source 101, such as a camera or storage device. The pre-processor 116 may process the input source video sequence as a series of frames and dynamically adjust the coding mode decision process to optimize resource usage. Typically, the pre-processor 116 analyses and conditions the source video for more efficient compression. For example, the image content of an input source video sequence may be evaluated to determine an appropriate coding mode for each frame.

The pre-processor 116 may additionally perform video processing operations on the frames including filtering operations such as de-noising filtering, bilateral filtering or other kinds of processing operations that improve efficiency of coding operations performed by the encoder 115. The pre-processor 116 may perform video processing operations to condition the source video sequence to render bandwidth compression more efficient or to preserve image quality in light of anticipated compression and decompression operations. The pre-processor 116 may include an array of filters (not shown) such as de-noising filters, sharpening filters, smoothing filters, bilateral filters and the like that may be applied dynamically to the source video based on characteristics observed within the video. The pre-processor 116 may include its own controller (not shown) to review the source video data from the camera and select one or more of the filters for application.

During image processing operations, the pre-processor 116 may measure the texture and brightness of the video data image content. The texture of the image content in a pixel block can be measured in any one of several methods, for example, as the mean-removed L1 norm of the pixel values in the block, the total variation (measured as the sum of the L1-norm of gradient) in the values of the pixels in the pixel block, or by edge detection. The brightness of image content in a pixel block can be measured as the mean of the luminance values for pixels in the pixel block.

The coding engine 117 may receive the processed video data from the pre-processor 116 and generate compressed video. Reference frames used to predictively code the video data may be decoded and stored in reference picture cache 208 for future use by the coding engine 117. The coded frames or pixel blocks may then be output from the coding engine 117 and stored by the data transmitter 119 where they may be combined into a common bit stream to be delivered by the transmission channel 135 to a decoder 125. The transmitter 119 may additionally format the coded video data for transmission, serve as a communications manager to merge coded video data stored at the transmitter 119 with other data to be transmitted to a decoder (such as audio or control data), and coordinate the output of the merged data to the channel 135.

The decoder 125 may include a receiver 126, a decoding engine 127, a reference picture cache 128 and a post-processor 129. The decoder 125 may receive the compressed video data from the channel 135 and prepare the video for display by inverting coding operations performed by the encoder 115 using the decoding engine 127. The decoder further may prepare the decompressed video data for display by filtering, de-interlacing, scaling or performing other processing operations on the decompressed sequence that may improve the quality of the video displayed with the post-processor 129. The processed video data may be displayed on a screen or other display 121 or may be stored in a storage device for later use.

Quantization, the effects of noise, the camera-capture process, unintentional or intentional pre-encoder blurring, image sub-sampling, interlacing and de-interlacing, and many other factors may cause distortion in the images of the video sequence. Many coding modes may be lossy processes that can induce distortion in the image data that is decoded and displayed at the decoder 125. Thus, the compression and transmission processes often result in a loss of edge detail and an overall blurry received video sequence. One source of distortion induced during the coding process is the coding mode applied to the picture on a pixel block by pixel block basis, which may cause artifacts at the seams between the pixel blocks.

As shown in FIG. 1, the functional blocks support video coding and decoding in one direction only. For bidirectional communication, an encoder 115 and decoder 125 may each be implemented at each terminal 110, 120 such that each terminal may capture video data at a local location and code the video data for transmission to the other terminal via the channel 135. Each terminal 110, 120 may receive the coded video data of the other terminal from the network 130, decode the coded data and display video data recovered therefrom.

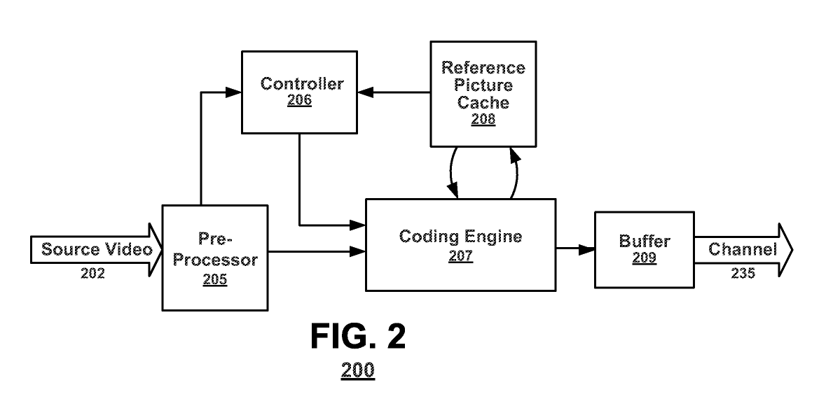

FIG. 2 is a simplified block diagram illustrating components of an exemplary encoder 200 according to an embodiment of the present invention. As shown in FIG. 2, the encoder 200 may include a pre-processor 205, a controller 206, a coding engine 207 a reference picture cache 208 and a coded video data buffer 209. The encoder 200 may receive an input source video sequence 202 from a video source. The pre-processor 205 may process the input source video sequence 202 as a series of frames and condition the source video for more efficient compression.

The controller 206 may receive the processed frames from the pre-processor 205 and determine appropriate coding modes for the pixel blocks of the received frames. Conventionally, to select a coding mode, a pixel block may be encoded several times, using various coding modes, in order to determine the best coding mode for the pixel block. To determine the best coding mode, the controller 206 may select a coding mode that satisfies one or more prerequisites. For example, the controller 206 may calculate the distortion induced by each mode and select a coding mode with distortion less than a predetermined distortion sensitivity threshold. Or the controller may select a coding mode that satisfies a bit rate requirement. Differently coded versions of the same pixel block and related coding parameters, including information about the coding technique used and other relevant data, may be stored until it can be reviewed by the controller 206 and a coding mode can be selected. Once a coding mode is selected, the controller 206 may control operation of the coding engine 207 to implement the selected coding mode by setting operational parameters. In accordance with an embodiment of the present invention, the controller 206 may attempt to code each pixel block with skip mode first. Then for each pixel block, the controller 206 may use the texture and brightness measurements for a pixel block to determine if the distortion induced by the skip mode can be effectively masked by the image content. If the distortion can be effectively masked, the pixel block may be encoded with skip mode. If the distortion cannot be effectively masked, then another coding mode may be selected.

Distortion may be less noticeable and therefore effectively masked by pixel blocks with image content that has high texture and high brightness than in pixel blocks with homogenous or dark content. The controller 206 may therefore set a distortion sensitivity threshold consistent with the amount of distortion the measured texture and brightness can effectively mask. Then the controller 206 may set the acceptable distortion sensitivity threshold higher for pixel blocks with image content that has high texture or high brightness and set the acceptable distortion sensitivity threshold lower for pixel blocks with image content that is low textured or dark.

The acceptable distortion that may be masked by the image content of the pixel block may vary dynamically, depending on the content of each pixel block. The amount of acceptable distortion and therefore the distortion sensitivity threshold may consequently vary with each pixel block, or may be set by the controller 206 for a single pixel block, multiple pixel blocks, a frame, or a sequence of frames.

As previously noted, during skip mode, the coding engine 207 may mark a block as skipped during encoding and copy a pixel block from a reference frame into a reconstructed picture during decoding. A skip mode coded pixel block may be directly copied from a co-located region of the reference frame into the reconstructed frame, or may be coded from a displaced region using an implied motion vector as determined by evaluating motion vectors of neighboring pixel blocks in the frame. The controller 206 may determine an implied motion vector for the skip mode coded pixel block by examining the motion vectors for neighboring pixel blocks. The implied motion vector may then be applied to select a replacement pixel block from the reference frame.

To determine distortion induced by the coding mode, the controller 206 may decode a coded frame or pixel block and calculate the distortion induced in a recovered frame. For skip mode encoded frames, distortion may be determined by comparing the source pixel block received from the pre-processor 205 to the identified replacement pixel block from the reference frame. Distortion may be calculated according to any method known in the art, for example, the minimum square error, the sum of the absolute differences (SAD), or the sum of the absolute transformed differences (SATD) of the error between a source pixel block and a recovered pixel block.

In accordance with an embodiment of the present invention, where distortion may be more noticeable at the seams between coded pixel blocks, the distortion considerations may give greater weight to distortion detected at the pixel block boundaries such that an artifact detected at a pixel block edge is given greater weight than an artifact detected at the center of the pixel block.

In accordance with an embodiment, distortion may be calculated for a pixel region larger than the pixel block. Using a larger pixel region in the distortion calculation may enable the controller 206 to identify distortion at the pixel block seams. For example, for a 16×16 pixel block, the controller 206 may evaluate distortion over a 19×19 region. Then, the distortion considerations may give greater weight to distortion detected at the pixel block boundaries within the larger pixel region such that an artifact detected at a pixel block edge is given greater weight than an artifact detected at the center of the pixel block. If there is significant distortion detected at the pixel block boundaries, where the original pixel block had less noticeable boundaries, then the detected distortion value may be greater, and therefore more likely to exceed the acceptable distortion sensitivity threshold.

The coding engine 207 may receive the processed video data from the pre-processor 205 and generate compressed video in accordance with the coding mode parameters received from the controller to achieve bandwidth compression. The coding engine 207 may operate according to a predetermined protocol, such as H.263, H.264, or MPEG-2. The coded video data, therefore, may conform to a syntax specified by the protocol being used.

Reference frames may be decoded and stored in the reference picture cache 208 for future use by the coding engine 207. The reference picture cache 208 may store frame data that represents source blocks for the skip mode and sources of prediction for later-received frames input to the encoder 200. The coded frames or pixel blocks may then be output from the coding engine 207 and stored by the coded video data buffer 209 where they may be combined into a common bit stream to be delivered by the transmission channel 235 to a decoder or terminal.

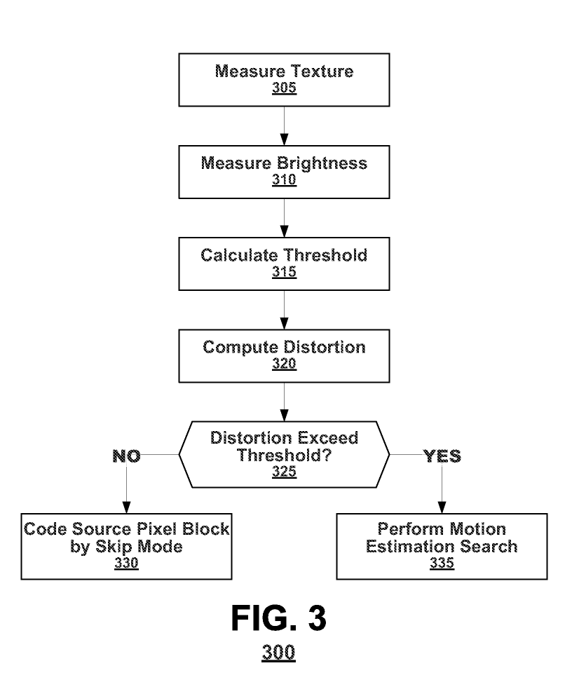

FIG. 3 is a simplified flow diagram illustrating a method 300 for selecting a coding mode according to an embodiment of the present invention. Bright and textured regions of a picture may more easily mask distortion and artifacts than homogenous or dark regions of a picture. An encoder may determine whether distortion induced by the coding mode selected for a pixel block may be effectively masked by the image content of the pixel block by measuring the brightness and/or texture of the pixel block and setting a distortion sensitivity threshold such that the estimated distortion for a given coding mode can be compared to the distortion sensitivity threshold to determine if the coding mode induced distortion is acceptable.

To determine if the distortion is acceptable, an encoder may first measure the texture (block 305) and the brightness (block 310) of the pixel block. The texture and brightness of image content in a pixel block can be measured by any one of several methods. For example, texture may be measured as the mean-removed L1 norm of the pixel values in the block, the total variation (measured as the sum of the L1-norm of gradient) in the values of the pixels in the pixel block, or by edge detection. The brightness of image content in a pixel block may be measured as the mean of the luminance values for pixels in the pixel block.

The encoder may then calculate a distortion sensitivity threshold representing the maximum distortion that would be acceptable and effectively masked given the measured texture and brightness (block 315). Because artifacts and distortion are less noticeable in a bright or a heavily textured pixel block, for pixel blocks with higher brightness and texture, the distortion sensitivity threshold may be higher than for homogenous or dark pixel blocks. The amount of acceptable distortion and therefore the distortion sensitivity threshold may consequently vary with each pixel block, or may be set for a single pixel block, multiple pixel blocks, a frame, or a sequence of frames.

The distortion between the source pixel block and reference pixel block used for the skip mode may then be calculated (block 320). The distortion may be calculated by coding the pixel block using the skip mode. Then the pixel block may be decoded and the reconstructed decoded pixel block compared to the original pixel block. The difference between the two may represent an estimation of the distortion introduced during the skip mode coding process. Distortion may be calculated according to any method known in the art, for example, the minimum square error, the sum of the absolute differences (SAD), or the sum of the absolute transformed differences (SATD) of the error between a source pixel block and a recovered pixel block.

The calculated distortion may be weighted at the boundaries of the pixel block such that distortion detected at the seams of the pixel blocks may be determined more significant than distortion detected at the center of the pixel block. Additionally, distortion may be calculated for a pixel region larger than the pixel block by using a larger pixel region in the distortion calculation to identify distortion at the pixel block seams. If there is significant distortion detected at the pixel block boundaries, then the detected distortion value may be greater than if significant distortion was detected solely in the center of the pixel block or uniformly across the pixel block.

The calculated distortion may then be compared to the acceptable distortion sensitivity threshold (block 325). If the calculated distortion does not exceed the acceptable distortion sensitivity threshold, the pixel block may be coded by skip mode (block 330). If the calculated distortion exceeds the acceptable distortion sensitivity threshold, the pixel block may be coded according to another coding mode (block 335). An estimation of motion may be performed to determine an appropriate predictive coding mode (i.e. I-coding or P-coding).

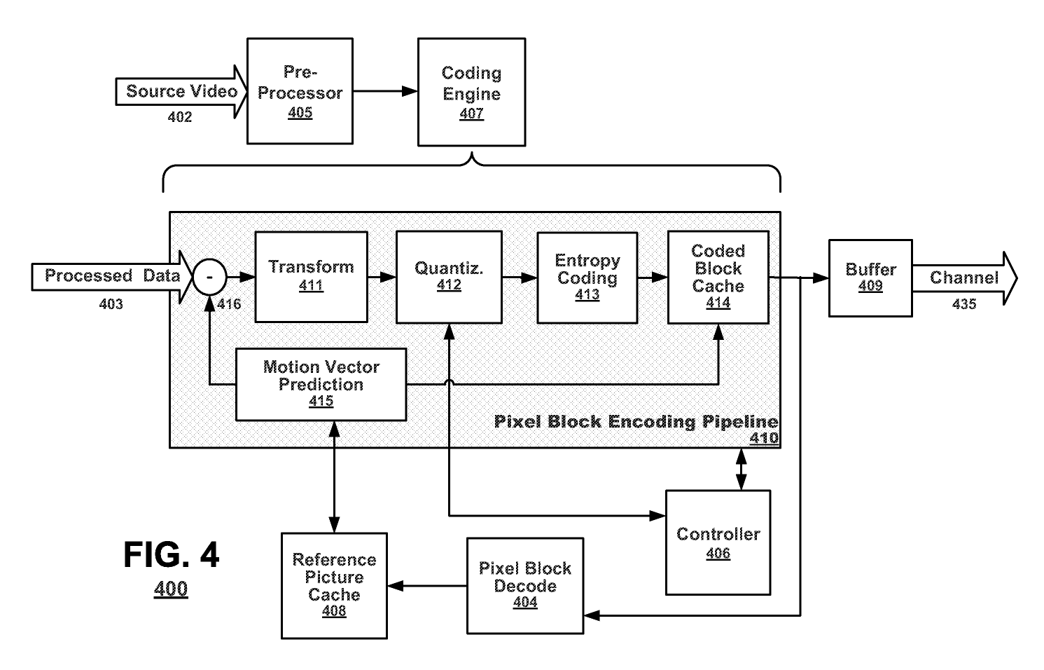

FIG. 4 is a simplified block diagram illustrating components of an exemplary video encoder 400 according to an embodiment of the present invention. As shown, encoder 400 may include a pre-processor 405, a coding engine 407 with a reference picture cache 408, a controller 406, a video data buffer 409, and a decoder 404. As previously noted, the encoder 400 may receive an input source video sequence 402 from a video source and the pre-processor 405 may process the input source video sequence 402 as a series of frames, analyze and condition the source video for more efficient compression, perform video processing operations on the frames including filtering operations, and determine the texture and brightness of the video data image content. The processed data and frames 403 may then be passed to the coding engine 407 to generate compressed video in accordance with the coding mode parameters received from the controller 406.

The coding engine 407 may include a pixel block encoding pipeline 410 further including a transform unit 411, a quantizer unit 412, an entropy coder 413, a motion vector prediction unit 415, a coded pixel block cache 414, and a subtractor 416. The transform unit 411 converts the incoming pixel block data into an array of transform coefficients, for example, by a discrete cosine transform (DCT) process or wavelet process. The transform coefficients can then be sent to the quantizer unit 412 where they are divided by a quantization parameter. The quantized data may then be sent to the entropy coder 413 where it may be coded by run-value or run-length or similar coding for compression. The coded data can then be sent to the motion vector prediction unit 415 to generate predicted pixel blocks. The motion vector prediction unit 415 may search among the reference picture cache for stored decoded frames that exhibit strong correlation with the source pixel block. When the motion vector prediction unit 415 finds an appropriate prediction reference for the source pixel block, it may generate motion vector data that is output to the decoder as part of the coded video data stream. Then the motion vector prediction unit 415 may retrieve a reference pixel block from the reference picture cache 408 for output to the subtractor 416 (via scalar and adder). The motion vector prediction unit 415 may also supply engine parameters such as parameters for prediction type and motion vectors for coding to the channel 435.

The subtractor 416 may compare the incoming pixel block data 403 to the predicted pixel block output from motion vector prediction unit 415, thereby generating data representative of the difference between the source pixel block and a reference pixel block developed for prediction. The subtractor 416 may operate on a pixel-by-pixel basis, developing residuals at each pixel position over the pixel block. Non-predictively coded pixel blocks may be coded without comparison to reference pixel blocks, in which case the pixel residuals are the same as the source pixel data.

The controller 406 may receive the processed frames from the pre-processor 405 and determine an appropriate coding mode for the processed frames. The controller may control operation of the coding engine 407 to implement each coding mode by setting operational parameters, for example the QP, and may select a coding mode to be utilized by the coding engine 407, including the skip mode. The controller 406 may set a QP according to the texture and brightness measurements of the frame image content. The QP may be set to reflect an acceptable level of quantization that will still mask the induced artifacts. The pixel blocks coded according to a selected coding mode may then be temporarily stored in the block cache 414 until they can be output from the encoding pipeline 410.

In accordance with an embodiment of the present invention, the controller 406 may additionally receive feedback from the coding engine 407, including the quantized prediction residuals output from the quantization unit 412. The quantized coefficients may be used to aid the decision to use skip mode. The magnitude of the quantized residuals may be compared to a predetermined threshold to determine the difference between the source pixel block and the reconstructed pixel block. Or the number of zeroes in the quantized residuals may be a factor in determining whether the skip mode is appropriate for the source pixel block. If the quantized residuals are above a predetermined threshold, or if there are few zeroes in the quantized residuals, coding the pixel block in skip mode may result in distortion that may not be effectively masked by the image content of the pixel block.

The value of the residuals calculated at the subtractor may additionally be a measure of the distortion that may be induced by the skip mode encoding. For example, the residuals for pixel blocks encoded with skip mode may be minimal where the reference frame is good. With skip mode, the pixel blocks in a co-located region of the reference frame may be copied as part of the recovered frame, then the residuals may represent the difference between the source pixel block and the reference pixel block.

In skip mode, if the residuals are small, the discrepancy between the source pixel block and the reference pixel block may be minimal and the induced distortion will therefore be minimal. If the residuals are larger, the discrepancy between the source pixel block and the reference pixel block may be more significant. A large discrepancy may result in an induced distortion that may exceed the threshold of acceptable distortion that can be effectively masked by the image content of the pixel block.

The controller 406 may receive feedback from the coding engine, including information on the residuals. The controller 406 may then compare the residuals to the acceptable distortion threshold calculated based on the texture, brightness or contrast of the pixel block content, and determine whether the distortion is small enough to be effectively masked by the pixel block image content. If the residuals are below the acceptable distortion threshold, the pixel block may be coded by skip mode. If the residuals exceed the acceptable distortion threshold, the controller 406 may select another coding mode for the pixel block.

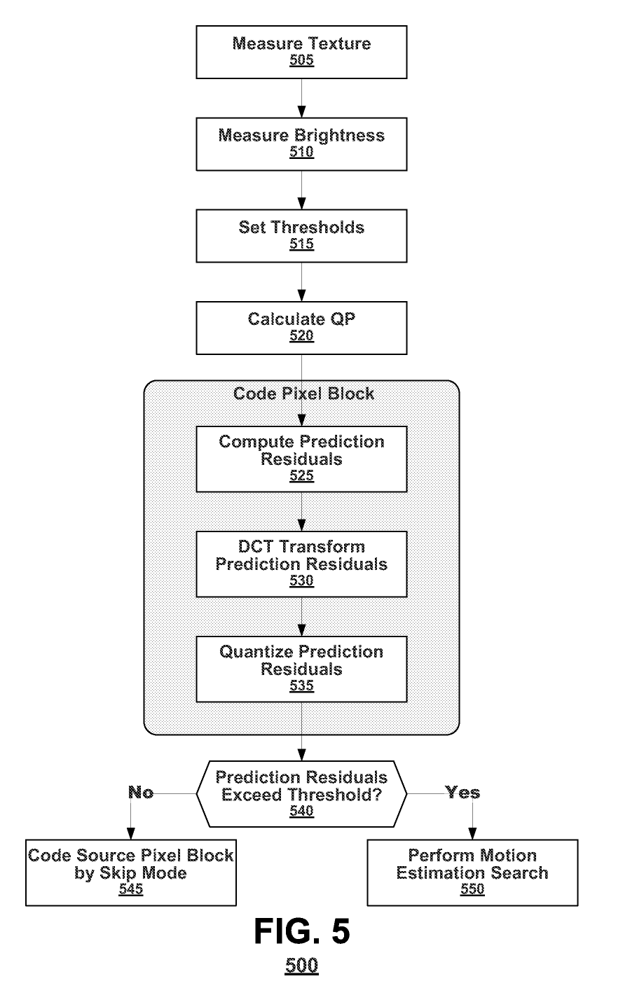

FIG. 5 is a simplified flow diagram illustrating a method 500 for selecting a coding mode according to an embodiment of the present invention. An encoder may determine whether distortion induced by the coding mode selected for a pixel block may be effectively masked by the image content of the pixel block by measuring the brightness and/or texture of the pixel block and determining if the brightness and texture will sufficiently mask the coding mode induced distortion. The induced distortion may be determined by evaluating the prediction residuals developed during the coding process.

To determine if the distortion induced by the selected coding mode for a pixel block is acceptable, an encoder may first measure the texture (block 505) and the brightness (block 510) of the pixel block. As previously noted, the texture and brightness of image content in a pixel block can be measured by any one of several methods. The encoder may then calculate thresholds reflecting the maximum acceptable distortion given the measured texture and brightness (block 515). The amount of acceptable distortion and therefore the distortion threshold may consequently vary with each pixel block, or may be set for a single pixel block, multiple pixel blocks, a frame, or a sequence of frames. Additionally, a quantization parameter (QP) may be calculated that would be acceptable given the measured texture and brightness (block 520). The QP may similarly be set for a single pixel block, multiple pixel blocks, a frame, or a sequence of frames.

The encoder may then code the pixel block according to the selected mode. In accordance with an embodiment of the present invention, the encoder will attempt encoding the pixel block using skip mode. Then the prediction residuals between the source pixel block and the reference pixel block that reflects the pixel block to be copied into the reconstructed frame upon decoding may be calculated as part of the coding process (block 525). The prediction residuals may then be transformed with the DCT transform (block 530). The coding engine transform unit outputs the transformed prediction residuals that may then be quantized with the calculated QP (block 535).

The cost of the selected coding mode calculated as a function of quantized transformed residuals may then be compared to the predetermined threshold (block 540). The comparison may evaluate, and compare to the predetermined thresholds, the magnitude of the quantized residuals, the number of zeroes resulting from the quantization, a function of zero-runs, the maximum magnitude of the quantized coefficients, or any quantifiable aspect of the quantized residuals. If the quantized residuals do not exceed the predetermined threshold(s), the pixel block may be coded with the skip mode (block 545). If the quantized residuals exceed the predetermined threshold(s), the pixel block may be coded according to another coding mode (block 550).

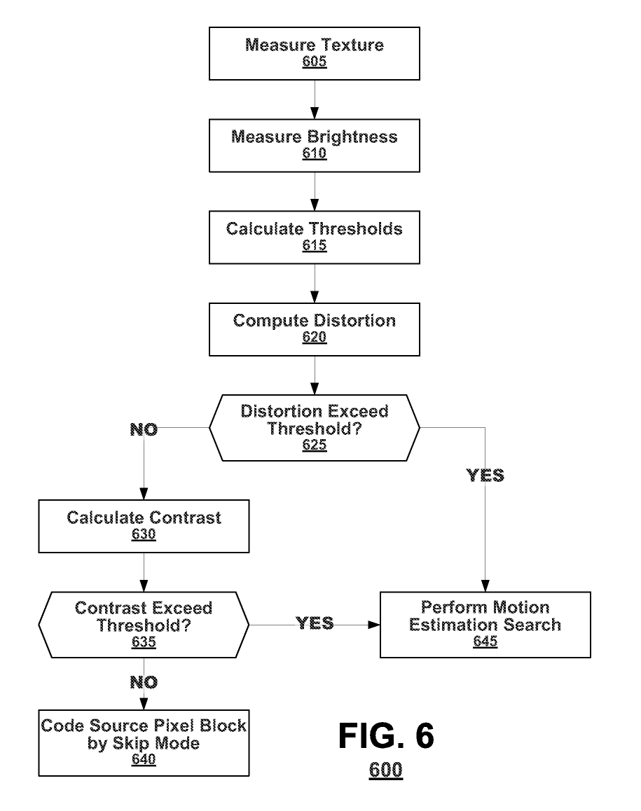

FIG. 6 is a simplified flow diagram illustrating a method 600 for selecting a coding mode according to an embodiment of the present invention. Bright and textured regions of a picture may more easily mask distortion and artifacts than homogenous or dark regions of a picture. However, a pixel block that is significantly different in texture or brightness from the neighboring pixel blocks may not mask distortion as effectively as a pixel block in a homogenous region. Therefore, an encoder may determine whether distortion induced by the coding mode selected for a pixel block may be effectively masked by measuring the brightness and/or texture of the pixel block and by measuring the brightness and/or texture of the surrounding pixel blocks. A distortion sensitivity threshold and a contrast threshold may be set such that the estimated distortion for a given coding mode can be compared to the distortion sensitivity threshold, and the contrast between the pixel block and the neighboring pixel blocks can be compared to the contrast threshold to determine if the coding mode induced distortion is acceptable.

To determine if the distortion is acceptable, an encoder may first measure the texture (block 605) and the brightness (block 610) of the pixel block. As previously noted, the texture and brightness of image content in a pixel block can be measured by any one of several methods. The encoder may then calculate a distortion sensitivity threshold representing the maximum distortion that would be acceptable and effectively masked given the measured texture and brightness, and a contrast threshold representing the maximum contrast that would be acceptable to effectively mask a distortion less than or equal to the distortion sensitivity threshold (block 615).

The distortion between the source pixel block and reference pixel block used for the skip mode may then be calculated (block 620). The distortion may be calculated by coding the pixel block using the skip mode. Then the pixel block may be decoded and the reconstructed decoded pixel block compared to the original pixel block. The difference between the two may represent an estimation of the distortion introduced during the skip mode coding process.

The calculated distortion may then be compared to the acceptable distortion sensitivity threshold (block 625). If the calculated distortion exceeds the acceptable distortion sensitivity threshold, the pixel block may be coded according to another coding mode (block 645). If the calculated distortion does not exceed the acceptable distortion threshold, the contrast for the neighboring pixel blocks may be calculated (block 630). The calculated contrast may then be compared to the contrast threshold (block 635). If the calculated contrast does not exceed the contrast threshold, the pixel block may be coded by skip mode (block 640). If the calculated contrast exceeds the acceptable contrast threshold, the pixel block may be coded according to another coding mode (block 645).

As discussed above, FIGS. 2 and 4 illustrate functional block diagrams of encoders. In implementation, the encoders may be embodied as hardware systems, in which case, the blocks illustrated in FIGS. 2 and 4 may correspond to circuit sub-systems within encoder systems. Alternatively, the encoders may be embodied as software systems, in which case, the blocks illustrated may correspond to program modules within encoder software programs. In yet another embodiment, the encoders may be hybrid systems involving both hardware circuit systems and software programs. For example, the coding engine 207 may be provided as an integrated circuit while the pre-processor 205 may be provided as software modules. Other implementations also may be used. Moreover, not all of the functional blocks described herein need be provided or need be provided as separate units. For example, although FIG. 2 illustrates the components of an exemplary encoder, such as the pre-processor 205 and controller 206, as separate units, in one or more embodiments, some or all of them may be integrated. Such implementation details are immaterial to the operation of the present invention unless otherwise noted above.

While the invention has been described in detail above with reference to some embodiments, variations within the scope and spirit of the invention will be apparent to those of ordinary skill in the art. Thus, the invention should be considered as limited only by the scope of the appended claims.

We claim:

1. A method for coding a video frame, comprising:
deriving, from image content of a source pixel block in the frame, a distortion sensitivity threshold for the source pixel block;
identifying a reference pixel block for skip mode coding the source pixel block;
calculating a distortion value for coding the source pixel block with the reference pixel block; and
coding the source pixel block with skip mode if the calculated distortion value is less than or equal to the distortion sensitivity threshold.

2. The method of claim 1, wherein the distortion sensitivity threshold is derived from brightness of the source pixel block.

3. The method of claim 2, wherein the brightness is measured as a mean of a luminance value for a plurality of pixel values in the source pixel block.

4. The method of claim 1, wherein the distortion sensitivity threshold is derived from texture of the source pixel block.

5. The method of claim 4, wherein the texture is measured as a mean-removed L1 norm of a plurality of pixel values in the source pixel block.

6. The method of claim 4, wherein the texture is measured as a total variation of a plurality of pixel values in the source pixel block.

7. The method of claim 4, wherein the texture is measured as a number of edges detected in the source pixel block.

8. The method of claim 1, wherein identifying a reference pixel block further comprises determining a motion vector for the source pixel block.

9. The method of claim 8, wherein the motion vector is calculated as an implied motion vector by evaluating motion vectors of a plurality of neighboring pixel blocks.

10. The method of claim 1, wherein the distortion value is calculated as a minimum square error of coding the source pixel block with the reference pixel block.

11. The method of claim 1, wherein the distortion value is calculated as a sum of absolute differences between the source pixel block and the reference pixel block.

12. The method of claim 1, wherein the distortion value is calculated as a sum of absolute transformed differences of the error in coding the source pixel block with the reference pixel block.

13. The method of claim 1 wherein the distortion sensitivity threshold is derived for each pixel block in the frame.

14. The method of claim 1 wherein the distortion sensitivity threshold is derived once for the frame.

15. The method of claim 1 wherein the distortion sensitivity threshold is derived once for a sequence of frames.

16. A method for coding a video frame, comprising:
deriving, from image content of each source pixel block in the frame, a distortion sensitivity threshold for the source pixel block;
coding the source pixel block with skip mode by:
calculating residuals between the source pixel block and a reference pixel block,
converting the residuals into an array of transform coefficients, and
quantizing the transform coefficients with a quantization parameter;
comparing an intermediate coding value to the distortion sensitivity threshold; and
coding the source pixel block with a predictive coding mode if the distortion sensitivity threshold is exceeded.

17. The method of claim 16, wherein the distortion sensitivity threshold is derived from brightness of the source pixel block.

18. The method of claim 16, wherein the distortion sensitivity threshold is derived from texture of the source pixel block.

19. The method of claim 16, wherein the intermediate coding value comprises a magnitude of the quantized coefficients.

20. The method of claim 16, wherein the intermediate coding value comprises a number of quantized coefficients equal to zero.

21. The method of claim 16, wherein the intermediate coding value comprises a magnitude of the calculated residuals.

22. The method of claim 16, further comprising calculating the quantization parameter for coding the source pixel block based on the distortion sensitivity threshold.

23. The method of claim 22, wherein the quantization parameter is calculated for each pixel block in the frame.

24. The method of claim 22, wherein the quantization parameter is calculated once for the frame.

25. The method of claim 22, wherein the quantization parameter is calculated once for a sequence of frames

26. The method of claim 16, further comprising:
calculating a contrast value between the source pixel block and at least one neighboring pixel block in the frame;
calculating a contrast threshold based on the distortion sensitivity threshold; and
coding the source pixel block with a predictive coding mode if the contrast value exceeds the contrast threshold.

27. The method of claim 26, wherein the contrast threshold is recalculated for each pixel block in the frame.

28. The method of claim 26, wherein the contrast threshold is calculated once for the frame.

29. The method of claim 26, wherein the contrast threshold is calculated once for a sequence of frames.

30. A video encoder, comprising:
a pre-processor to perform processing operations on an input video sequence and prepare a series of frames for coding;
a reference frame cache to store reference frames for coding the frames;
a controller to select a coding mode for a source pixel block in a frame by:
setting a distortion sensitivity threshold,
identifying a reference pixel block from a reference frame stored in the reference frame cache for skip mode coding the source pixel block, and
calculating a distortion value for coding the source pixel block with the reference pixel block;
a coding engine to code the source pixel block with skip mode if the calculated distortion value is less than or equal to the distortion sensitivity threshold.

31. The method of claim 30, wherein the distortion sensitivity threshold is derived from brightness of the source pixel block.

32. The method of claim 30, wherein the distortion sensitivity threshold is derived from texture of the source pixel block.

33. The encoder of claim 30 wherein the coding engine further comprises:
a subtractor to calculate residuals between the source pixel block and the reference pixel block;
a transform unit to convert the residuals into an array of transform coefficients; and
a quantizer unit to quantize the transform coefficients with a quantization parameter;
wherein the distortion value is based on one of the intermediate outputs of the coding engine.

34. The encoder of claim 30 wherein the controller calculates a contrast value between the source pixel block and at least one neighboring pixel block in the frame, calculates a contrast threshold based on the distortion sensitivity threshold, and the coding engine codes the source pixel block with a predictive coding mode if the contrast value exceeds the contrast threshold.

35. A computer readable medium storing program instructions that, when executed by a processing device, cause the device to:
derive from image content of a source pixel block in a video frame, a distortion sensitivity threshold for the pixel block;
identify a reference pixel block from a reference frame for skip mode coding the source pixel block;
calculate a distortion value for coding the source pixel block with the reference pixel block; and
code the source pixel block with skip mode if the calculated distortion value is less than or equal to the distortion sensitivity threshold.

36. The method of claim 35, wherein the distortion sensitivity threshold is derived from brightness of the source pixel block.

37. The method of claim 35, wherein the distortion sensitivity threshold is derived from texture of the source pixel block.
